(19) United States
(12) Patent Application Publication
(10) Pub. No.: US 2026/0349957 A1
(43) Pub. Date: Nov. 5, 2026

(54) APPARATUS AND METHOD FOR INTERFACING WITH A VECTOR PROCESSOR

(71) Applicant: Simplex Micro, Inc., Tustin, CA (US)

(72) Inventor: Thang Minh Tran, Tustin, CA (US)

(73) Assignee: Simplex Micro, Inc., Tustin, CA (US)

(21) Appl. No.: 19/664,557

(22) Filed: Apr. 30, 2026

Related U.S. Application Data
(60) Provisional application No. 63/800,429, filed on May 5, 2025.

(51) Int. Cl. G06F 15/80

(52) U.S. Cl. CPC G06F 15/8069

(57) ABSTRACT

A microprocessor-based data processing system includes a microprocessor, a vector coprocessor, an interface module, a memory interface module, and a level 2 cache for executing vector load and store instructions. The processing system includes a mechanism to track the vector instruction through of the microprocessor and vector coprocessor. The memory interface module and level 2 cache provide an efficient protocol to optimize for single or multiple cache lines vector load or store operations.

### RELATED APPLICATIONS

This application claims priority to U.S. provisional application 63/800,429, filed on May 5, 2025, which application is hereby incorporated by reference in its entirety.

This application is related to the following U.S. patents and/or applications which are each hereby incorporated by reference in their entirety: U.S. Patent 12,282,772, granted Apr. 22, 2025 and entitled “Vector Processor with Vector Data Buffer;” U.S. Patent Publication 2024/033822, filed Mar. 12, 2024, and entitled “Apparatus and Method for Implementing Many Different Loop Types in a Microprocessor;” U.S. Patent 12,541,369, granted Feb. 3, 2026, and entitled “Executing Phantom Loops in a Microprocessor;” U.S. Patent 12,147,812, granted Nov. 19, 2024, and entitled “Out-of-Order Execution of Loop Instructions in a Microprocessor;” and U.S. Patent Number 12,112,172, granted Oct. 8, 2024, and entitled “Vector Microprocessor with Time Counter for Statically Dispatching Instructions.”

### TECHNICAL FIELD

The present invention relates to the field of computer processors. More particularly, it relates to interfacing between a microprocessor and a vector processor where the processor consists of a general-purpose microprocessor, a digital-signal processor and where the vector processor consists of a single instruction multiple data processor, a tensor processing unit, a graphics processor, or other type of microprocessor.

### Technical Background

Processors have extended to include processing of vector instructions to improve performance of applications. In such instances, the vector register file can have a large data width, for example, of 512 bits to several thousand bits. The vector register in such implementations typically consists of many elements with a programmable element data width. For example, a vector register width of 1024 bits can have widths of 128 elements of 8-bits, 64 elements of 16-bits, 32 elements of 32-bits, or 16 elements of 64-bits. The vector processor performance is improved by operating on several elements in parallel. However, with large register files, it is much more difficult to load and store vector data from memory. Vector load and store are especially difficult when the memory addresses of the data elements are not consecutive in memory. For example, in a worst case, a vector register with 32 elements can require 32 load/store operations to complete loading or storing of a vector register. As is known, the vector processor executes only vector instructions and not general-purpose instructions which requires a microprocessor. In typical design, the microprocessor or CPU sends instructions and control the memory data to the vector processor.

Thus, there is a need for a protocol and interface module between a CPU and a vector processor which can be used for any CPU and any vector processor.

### SUMMARY

The data width for most microprocessors (CPUs) is most commonly 64 bits, which an architectural register file can utilize to rename the registers for out-of-order execution wherein the physical register file is 2 to 32 times the architectural register file. In comparison, the vector register width of a vector processor unit (VPU) is 512 to several thousand bits, which is expensive for register renaming. In order to execute a vector instruction out-of-order, a set of conditions should be established by the CPU as part of the interface protocol. The conditions for vector instructions in the VPU consists but is not limited to: execution after the write back stage, solving of data dependency without using register renaming, and scheduling of hundreds of instructions through a loop buffer.

The vector load and store instructions disclosed herein are defined as 3 different types: (1) unit load/store where the elements of a vector register are in consecutive memory locations, (2) stride load/store where the elements of a vector register are in stride (where stride = x) memory locations, and (3) index load/store where the elements of a vector register are in random memory locations. The unit load is simple to handle but the other 2 types of vector load and store instructions require an address calculation for each element. In the worst case, each element is accessed as an individual load/store instruction where a vector register with 32 elements becomes 32 load/store operations, defeating the purpose of parallel execution of the elements in a vector processor. In one embodiment, the VPU interfaces directly to a L2 cache (L2C) or local vector memory (LVM) where multiple data banks can be fetched in a single cycle and processed through a permutation module for stride and index load/store operation.

The disclosed embodiments use a processor and vector coprocessor with a time counter and a method for statically dispatching instructions to an execution pipeline with preset execution times based on a time count from the time counter.

The disclosed VPU design employs static scheduling of instructions. A static scheduling algorithm is based on the assumption that a new instruction has a perfect view of all previous instructions in the execution pipeline, and thus it can be scheduled for execution at an exact time in the future, e.g., with reference to a time count from a counter. Assuming an instruction has 3 source operands and 1 destination operand, the instruction can be executed out-of-order when conditions are met of (1) no data dependencies, (2) availability of read buses to read data from the register file, (3) availability of a functional unit to execute the instruction, and (4) availability of a write bus to write result data back to the register file. The static scheduling issues the vector instructions as long as the above four conditions are met. The time counter can be frozen if the result data does not return at the expected time.

In an artificial intelligence (AI) application, the code often consists of kernel loops where the number of iterations can be in hundreds or thousands. The expected vector load/store instructions in a loop address the same type of memory where the predicted latency time of the vector load/store operation has a fixed increment. The loop instructions can be scheduled in an execution queue similar to that disclosed in U.S. Patent 12,147,812 and U.S. Patent 12,541,369. In another embodiment the loop instructions can be held in an instruction buffer similar to that disclosed in U.S. Publication 2024/0338220.

The four conditions above are associated with time: (1) a time when all data dependencies are resolved, (2) at which time the read buses are available to read source operands from a register file, (3) at which subsequent time the functional unit is available to execute the instruction, and (4) at which further subsequent time the write bus is available to write result data back to the register file.

A disclosed processor-based data processing system includes a coprocessor coupled to a processor where the data processing system includes an interface module comprising a plurality of registers to receive coprocessor instructions from the processor. The interface module also includes a plurality of registers to receive status information from the coprocessor wherein the status information from the coprocessor includes a coprocessor queue entry number which is used to track a corresponding coprocessor instruction through pipelines of the processor and the coprocessor. A level two cache stores data of the coprocessor. Data for the coprocessor is not from a data cache of the processor and a coprocessor load and store instruction is tagged with a coprocessor queue entry number. The data processing system also includes a memory interface module that includes a plurality of first registers to receive coprocessor data from the level two cache to send to the coprocessor. A plurality of second registers receives coprocessor data from the coprocessor to send to the level two cache. Coprocessor data in the memory interface module is tagged with the coprocessor queue entry number.

Further disclosed herein is a computer program product that issues a coprocessor instruction to a processor. The computer program product is stored on a non-transitory computer readable storage medium and includes instructions for causing a computer system to execute a method that is executable by a data processing system where the method includes, assigning a coprocessor queue entry number through an interface module to the coprocessor instruction to track a coprocessor instruction progress through pipelines of the coprocessor and the processor. The processor commits or cancels, via the interface module, the coprocessor instruction and sends, via a memory interface module, coprocessor load data to the coprocessor from a level two cache. Coprocessor store data is received to the level two cache through the memory interface module.

### BRIEF DESCRIPTION OF THE DRAWINGS

Aspects of the present invention are best understood from the following description when read with the accompanying figures.

FIG. 1 is a block diagram illustrating a processor-based data processing system in accordance with a preferred embodiment of the present invention;

FIG. 2 is a block diagram illustrating an embodiment of the vector co-processor of the data processing system of FIG. 1;

FIG. 3 is a block diagram illustrating an embodiment of the interface module of the data processing system of FIG. 1;

FIG. 4 is a block diagram illustrating an embodiment of the memory interface module of the data processing system of FIG. 1; and

FIG. 5 is a block diagram illustrating an embodiment of the level 2 cache of the data processing system of FIG. 1.

### DETAILED DESCRIPTION

The following description provides different embodiments for implementing aspects of the present invention. Specific examples of components and arrangements are described below to simplify the explanation. These are merely examples and are not intended to be limiting. For example, the description of a first component coupled to a second component includes embodiments in which the two components are directly connected, as well as embodiments in which an additional component is disposed between the first and second components. In addition, the present disclosure repeats reference numerals in various examples. This repetition is for the purpose of clarity and does not in itself require an identical relationship between the embodiments. The connectors between elements show general data or control flow to facilitate understanding by those skilled in the art and do not necessarily show every connection between any given elements.

In one embodiment, a processor is provided, typically implemented as a microprocessor in which instructions including vector instructions into be scheduled and executed. In such a microprocessor, the instructions can be executed speculatively and are tracked to retire in order. In some cases, the instructions can be cancelled due to branch misprediction or exception. In another embodiment, the instructions can be executed non-speculatively but the instructions in the decode and issue stages are flushed due to branch misprediction or exception. The vector instructions are issued to vector coprocessor in decode stage must be validated or cancelled/flushed by the microprocessor.

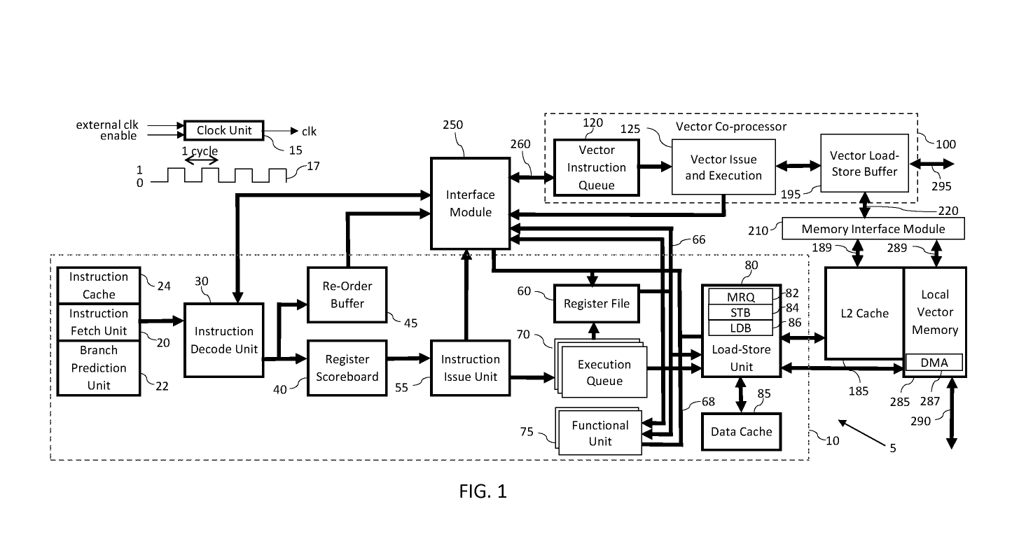

FIG. 1 is a block diagram of a microprocessor-based data processing system 5. The exemplary system includes a microprocessor 10 having a clock unit 15, an instruction fetch unit 20, a branch prediction unit 22, an instruction cache 24, an instruction decode unit 30, a register scoreboard 40, re-order buffers 45, an instruction issue unit 55, a register file 60, a plurality of execution queues 70, a plurality of functional units 75, a load-store unit 80, and a data cache 85. The microprocessor 10 includes a plurality of read buses 66 connecting the register file 60 to interface module 250, the functional units 75, and load-store unit 80. The microprocessor 10 also includes a plurality of write buses 68 to write result data from vector issue and execution pipeline unit 125 of vector coprocessor 100, the functional units 75, and the load-store unit 80 to the register file 60. The load-store unit 80 includes a load buffer 86 and a store buffer 84 to keep track of the order of load and store instruction for memory data dependency and a miss request queue 82 to keep track of miss requests to external memory outside of the processor 10. The L2 cache 185 is the second level cache which is much larger than the data cache 85 and the instruction cache 24. The L2 cache 185 is coupled to the data cache 85 and coupled (not shown) to the instruction cache 24. If the required data are not in the data cache 85 or the instruction cache 24, then the miss request is sent to the L2 cache 185. The re-order buffer 45 is used to track the order of the instructions as they are decoded in order from the instruction decode unit 30.

The microprocessor 10 interfaces with the vector coprocessor 100 through interface module 250 and controls the memory interface module 210 through the L2 cache (L2C) 185, the local vector memory (LVM) 285, and to external memory (not shown). The vector coprocessor 100 includes a vector instruction queue 120, a vector issue and execution pipeline 125 and a vector load-store buffer 195. The vector coprocessor 100 couples to interface module 250 through bus 260, to memory interface module 210 through bus 220, and to external memory (not shown) through bus 295. The LVM 285 is specifically implemented for the vector coprocessor 100 where the LVM 285 consists of multiple memory blocks wherein each memory block contains a start address with a block size equivalent to multiple cache lines. The direct memory access (DMA) module 287 is programmed by the microprocessor 10 to prefetch data into the memory blocks. The data from external memory (not shown) is coupled to the LVM 285 through the bus 290. Note that the DMA 287 can be programmed to receive or send data to the external memory through the bus 290.

The instructions can be executed out-of-order and the re-order buffer 45 retires instructions in-order. The vector instructions are committed in-order by the re-order buffer 45 where “commit” means the vector instruction is valid and cannot be cancelled by branch misprediction or flushed by exception. Herein (1) “complete” means that an instruction is executed with the result data which can be written into a temporary register, an architectural register, or a register file, (2) “commit” means that an instruction cannot be flushed, and the instruction can be executed and written back to the architectural register at any time, (3) “retire” means that result data is written back to the architectural register. In the microprocessor 10, the vector instructions are committed by the re-order buffer 45 and are then executed and completed, possibly out-of-order, and retired to a vector register file in the vector coprocessor 100.

Microprocessor 10 and vector coprocessor 100 take the form of a synchronous microprocessor where the clock unit 15 generates a clock signal (“clk”) which couples to all the units in the microprocessor 10 and the vector coprocessor 100. The clock unit 15 provides a continuously toggling logic signal 17 which toggles between 0 and 1 repeatedly at a clock frequency. The clock output signal (“clk”) of clock unit 15 enables synchronization of the many different units and states in the microprocessor 10 and the vector coprocessor 100. The clk signal is used to sequence data and instructions through the units that perform the various computations in the microprocessor 10 and the vector coprocessor 100. The clock unit 15 may include an external clock as input to synchronize the microprocessor 10 and the vector coprocessor 100 with external units (not shown). The clock unit 15 may further include an enable signal to disable the clock unit when the microprocessor is in an idle stage or not used for instruction execution.

In one embodiment, the register scoreboard 40 resolves data dependencies in the instructions. The instruction issue unit 55 and the execution queues 70 check availability of the various resources, which in one embodiment include the read buses 66, the functional units 75, the load-store unit 80, and the write buses 68 to dispatch instructions to the functional units 75 or the load-store unit 80. The specified action can be reading data from the register file, writing data to the register file, issuing an instruction to a functional unit for execution, or some other action. In general, the CPU 10 executes the instruction, writes back to the register file 60, and sets the completion bit in the re-order buffer 45.

In the microprocessor 10, the instruction fetch unit 20 fetches the next instruction(s) from the instruction cache 24 to send to the instruction decode unit 30. The number of instructions per cycle can vary and is dependent on the number of instructions per cycle supported by the processor 10. For higher performance, microprocessor 10 fetches more instructions per clock cycle for the instruction decode unit 30. For low-power and embedded applications, microprocessor 10 might fetch only a single instruction per clock cycle for the instruction decode unit 30. If the instructions are not in the instruction cache 24 (commonly referred to as an instruction cache miss), then the instruction fetch unit 20 sends a request to external memory (not shown) to fetch the required instructions. The external memory may consist of hierarchical memory subsystems, for example, an L2C, an L3 cache, read-only memory (ROM), dynamic random-access memory (DRAM), flash memory, or a disk drive. The external memory is accessible by both the instruction cache 24 and the data cache 85. The instruction fetch unit 20 is also coupled to the branch prediction unit 22 for prediction of the next instruction address when a branch is detected and predicted by the branch prediction unit 22. The instruction fetch unit 20, the instruction cache 24, and the branch prediction unit 22 are described here for completeness of a microprocessor 10. In other embodiments, other instruction fetch and branch prediction methods can be used to supply instructions to the instruction decode unit 30 for microprocessor 10.

The instruction decode unit 30 is coupled to the instruction fetch unit 20 for new instructions and also coupled to the register scoreboard 40. The instruction decode unit 30 decodes the instructions for instruction type, instruction throughput and latency times, and the register operands. The register operands, for example, may consist of 2 source operands and 1 destination operand. The operands are referenced to registers in the register file 60. The source and destination registers are used here to represent the source and destination operands of the instruction. The source registers support solving read-after-write (RAW) data dependencies. If a later instruction has the same source register as the destination register of an earlier instruction, then the later instruction has RAW data dependency. The later instruction must wait for completion of the earlier instruction before it can start execution. The RAW data dependency is often referred to as true dependency and is applied to all types of instructions including vector instructions. The vector instructions may read and write to the register file 60 and are tracked by the register scoreboard 40 as part the main pipeline of the processor 10.

The instruction decode unit 30 decodes all instruction types and allocates an entry in the re-order buffer (ROB) 45. The ROB entry number is used to track the instruction in the microprocessor 10 pipeline. If the ROB 45 is full, then the instruction is stalled in decode until ROB entries are available. The ROB 45 is needed to retire the instructions in order regardless of when the instructions are executed and written back to the register file 60. In one embodiment, ROB 45 takes the form of a first in first out (FIFO) buffer. Inputs are instructions from the decode unit 30 and instructions are retired in order after completion by the functional unit 75 or the load store unit 80. In particular, the ROB 45 flushes all instructions after a branch misprediction or instruction exception. In one embodiment, the ROB 45 retires the instructions that are executed in the main execution pipeline and commits the vector instructions that were sent to the vector instruction queue 120. The vector instruction queue 120 holds the vector instructions until they are committed by the ROB 45, at which time the committed vector instructions can be scheduled for execution in the vector issue and execution pipeline 125. Another function of the ROB 45 is controlling writing of data to memory only in accordance with the order of the load and store execution. The data memory (including data cache 85, L2C 185, LVM 285, and external memory) should be written in order by retiring of the store instructions from the ROB 45. From the point of view of the vector coprocessor 100, the data cache 85, L2C 185, LVM 285, and external memory are hereby collectively referred to as vector data memory.

In a similar mechanism, the instruction decode unit 30 decodes vector instructions and allocates an entry in the vector instruction queue (VIQ) 120 of the vector coprocessor 100 where the vector instruction is stalled in the decode unit 30 if the VIQ 120 is full. As part of the interface module 250, the microprocessor 10 informs the vector instruction status using the VIQ entry to the vector coprocessor 100. The status of the vector instruction stored in the interface module 250 includes but is not limited to executing of the vector instruction from the execution queue 70, cancelling or retiring of the vector instruction by the ROB 45, and timing and status of the vector load and store instruction in the load-store unit 80 to the memory interface module 210.

The load-store unit 80 resolves memory data dependency for all load and store instructions. In one embodiment, the load-store unit 80 includes a load buffer (LDB) 86, a store buffer (STB) 84, and a miss request queue (MRQ) 82. In one embodiment, a store buffer entry is allocated in the decode unit 30 when a store instruction is decoded for tracking of the store instruction in the execution pipeline in the similar manner as with assigning a VIQ entry for a vector instruction. Similarly, a load buffer entry is allocated in the decode unit 30 when a load instruction is decoded. The current write pointer of the store buffer 84 is attached to the load instruction in which the store buffer entry is used to track the memory order of the load instruction with respect to older store instructions. The load instruction address must be compared to all older store instruction addresses in the store buffer 84 in case of an address match to forward data from the store to load instruction. Similarly, the current write pointer of the load buffer 86 is attached to the store instruction in which the load buffer entry is used to track the memory order of the store instruction with respect to the younger load instruction. The load instruction can be executed out-of-order with respect to the store instruction in which case the load instruction is completed before the store address of an older store instruction is not yet calculated. In this case, when the store address is calculated, the store address must be compared to all completed younger load instructions in the load buffer 86 and an address match should resolve into flushing and re-fetching of the younger load instruction.

In another embodiment, the load buffer 86 and the store buffer 84 keep only the entry which is hit in the data cache 85. If the load entry in the load buffer 86 is not (cache miss) in the data cache 85, then the load instruction takes an entry in the miss request queue 82. The miss request queue 82 sends the load miss address to L2 cache 185 to fetch the cache line. The load miss entry in the load buffer 86 is invalidated by the ROB 45 when the addresses of all earlier load and store instructions are calculated. If the store entry in the store buffer 84 is not (cache miss) in the data cache 85, then the store instruction takes an entry in the miss request queue 82. The miss request queue 82 sends the store miss address to L2 cache 185 to fetch the cache line. The store instruction must remain in the store buffer 84 until the store instruction is retired by the ROB 45 at which time the store entry in the store buffer 84 sends store data to the miss request queue 82. The memory order of the cache hit entries are detected in the store buffer 84 and the load buffer 86 while the memory order of the cache miss entries is handled by the miss request queue 82. The load and store address arrive at the miss request queue 82 out-of-order and the memory order of the load and store instructions are established by the ROB 45.

In one embodiment, the vector load and store instructions access the L2C 185 directly where a vector load or store instruction accesses the L2C 185 concurrently with accessing the data cache 85. A vector load or store instruction that hits in the data cache 85, or an earlier entry in the store buffer 84, or the load buffer 85, or the miss request queue 82 may cause the vector load or store instruction to wait until all the memory order issues are resolved before accessing the L2C 185 again.

Each of the units shown in the block diagrams herein can be implemented in integrated circuit form by one of ordinary skill in the art in view of the present disclosure. The integrated circuitry employed to implement the units shown herein may be expressed in various forms including as a netlist which takes the form of a listing of the electronic components in a circuit and the list of nodes that each component is connected to. Such a netlist may be provided via an article of manufacture as described below.

In other embodiments, the units shown herein can be implemented as software representations, for example in a hardware description language (such as for example Verilog) that describes the functions performed by such units at a Register Transfer Level (RTL) type description. The software representations can be implemented employing computer-executable instructions, such as those included in program modules and/or code segments, being executed in a computing system on a target real or virtual processor. Generally, program modules and code segments include routines, programs, libraries, objects, classes, components, data structures, etc. that perform particular tasks or implement particular abstract data types. The program modules and/or code segments may be obtained from another computer system, such as via the Internet, by downloading the program modules from the other computer system for execution on one or more different computer systems. The functionality of the program modules and/or code segments may be combined or split between program modules/segments as desired in various embodiments. Computer-executable instructions for program modules and/or code segments may be executed within a local or distributed computing system. The computer-executable instructions, which may include data, instructions, and configuration parameters, may be provided via an article of manufacture including a non-transitory computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

The aforementioned implementations of software executed on a general-purpose, or special purpose, computing system may take the form of a computer-implemented method for implementing a microprocessor, and also as a computer program product for implementing a microprocessor, where the computer program product is stored on a non-transitory computer readable storage medium and include instructions for causing the computer system to execute a method. The aforementioned program modules and/or code segments may be executed on suitable computing system to perform the functions disclosed herein. Such a computing system will typically include one or more processing units, memory and non-transitory storage to execute computer-executable instructions.

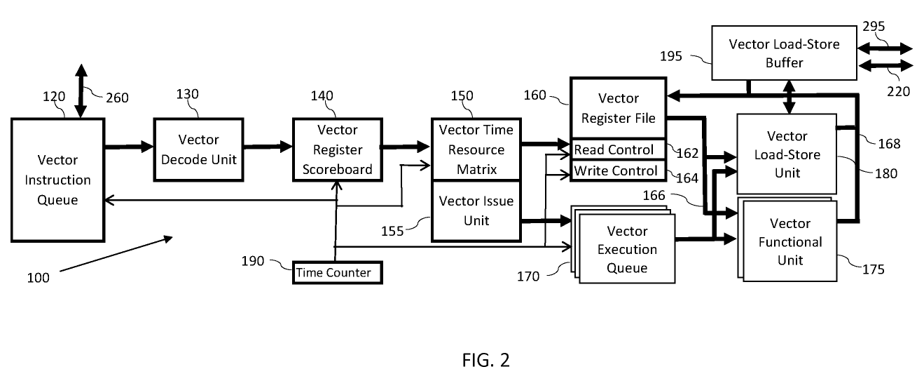

FIG. 2 illustrates a block diagram of a preferred embodiment of vector coprocessor 100. The modules of the vector coprocessor 100 are numbered corresponding to the modules in the main pipeline of the microprocessor 10 by adding 100 to the reference number. The vector coprocessor 100 includes a vector instruction queue 120, a vector decode unit 130, a vector register scoreboard 140, a vector time-resource matrix 150, a vector issue unit 155, a vector register file 160, a read control unit 162, a write control unit 164, a plurality of vector execution queues 170, a plurality of vector functional units 175, and a vector load-store unit 180. The vector coprocessor 100 includes a plurality of read buses 166 connecting the vector register files 160 to the vector functional units 175 and vector load-store unit 180. The vector coprocessor 100 also includes a plurality of write buses 168 to write result data from the vector functional units 175 and the vector load-store unit 180 to the vector register file 160. The vector load-store unit 180 consists of multiple buses to the external memory through the bus 295 and the bus 220 which couples to the memory interface module 210 which couples to the L2C 1 85 and the LVM 285. The functionality of the modules in the vector coprocessor 100 is similar to those of the main pipeline of the microprocessor 10. In one embodiment, the vector coprocessor 100 schedules instructions to be executed at a preset time based on a time count from a time counter. In such a vector coprocessor the vector instructions are scheduled to be executed using the known throughput and latency of each vector instruction to be executed.

According to an embodiment, the vector coprocessor 100 also includes a time counter unit 1 90 which stores a time count incremented, in one embodiment, every clock cycle. The time counter unit 190 is coupled to the clock unit 15 and uses “clk” signal to increment the time count. The time counter 190 allows the time count to be frozen when load data from vector data memory do not return at a preset time.

The memory interface module 210 sends an expected latency time to the vector load store buffer (VLSB) 195. This latency time is added to the current time count from the time counter 190 to form the future preset time (referred to as load time) in which valid load data is expected to be valid from the vector data memory. The vector load instruction from the VIQ 120 uses the load time from the VLSB 195 to set the write time for the destination register of the vector load instruction in the vector register scoreboard 140 when the instruction is issued from the instruction issue unit 155. The execution queue 170 of the vector load instruction is sent to the vector load-store unit 180 to read the load data from the VLSB 195 to write to vector register file 160 at the preset write time in the vector register scoreboard 140. If the load data in the VLSB 195 is not valid for the vector load-store unit 180 to read, then the time counter 190 is frozen until the load data in the VLSB 195 is valid. The frozen time count prevents the dependent instruction from reading the invalid data in the vector register file 160.

For the vector coprocessor 100, the vector register data width is typically quite large, i.e., 512 bits to several thousand bits, and adding temporary vector registers is very expensive in area, thus in the disclosed embodiment the vector registers are not renamed. The vector register scoreboard 140 is designed to prevent data dependency for the vector instructions. In this context, data dependency includes read-after-write (RAW), write-after-write (WAW), and write-after-read (WAR). The RAW data dependency means that the first instruction must write result data to a register before second instruction read data from the same register. The WAW data dependency means that the second write to the same destination vector register must not happen before the first write is done. The WAR data dependency means that the second write to a register must not happen before the first instruction finishes reading the register. Each register identified in the vector register scoreboard 140 has associated therewith a write time and a read time. The write time of a register provides the earliest time that the second instruction can read the register for RAW data dependency. The write time of a register also provides the earliest time that the second instruction can write the register for WAW data dependency. The read time of a register provides the earliest time that the second instruction can write to the register. The vector register scoreboard 140 is used to solve data dependency of the second (later) instruction.

Solving data dependency of an instruction is one of the four conditions for executing of an instruction. The other 3 conditions involve the availability of the read ports of the register file 160, the write ports of the register file 160, and the functional unit 170 or the load store ports of the load-store unit 180. The time-resource matrix 150 by storing status of the resources is effectively a recording of the busy indication of the resources. Each row of the time-resource matrix 150 represents a time count, and each column represents status of a resource which includes the read ports, the write ports, the functional units, and the load-store ports. For example, with time count of 128, there are 128 rows to indicate at a particular time count which resources are busy or available. The source and destination registers of an instruction access the vector register scoreboard 140 for the corresponding read and write times at which the worst case time based RAW, WAW, and WAR data dependency is calculated to access the time resource matrix 150 to make sure that the resources are available. In one embodiment, the preset time and preset time +1 are used to look up the time-resource matrix 150 for a second option of when to issue the instruction at the preset time +1.

The vector load and store instructions are a special case because they are in both the main execution pipeline of the processor 10 and the vector coprocessor 100. The base addresses of the vector load and store instructions use the registers from the register file 60. Each element of the vector register has a corresponding memory address which is calculated differently for 3 types of vector load and store instructions. For index load/store, the element addresses are calculated using a vector register. The load/store data are from the memory to the vector register file 160. The load/store address calculation is in the main pipeline of processor 10 where the address attributes and protection are performed by the load store unit 80. The load store unit 80 accepts speculative instructions, as with all the instructions in the main pipeline, where the load/store instruction can be flushed by a branch misprediction or an exception. The load and store instructions in the vector load store unit 180 are executed only after the commit point indicated by the re-order buffer 45. In one embodiment, the custom vector load/store instruction includes a direct-memory access (DMA) instruction to transfer data between the LVM 285 from external memory. The load store unit 80 and the vector load store unit 180 can operate asynchronously from each other. The vector load and store buffers are used to synchronize data between the load store units based on the valid vector data in the buffers.

Since the vector data can be thousands of bits, handling of load and store data must be treated differently than the traditional microprocessor load and store instruction. First, the load and store data width can be several cache lines and the vector memory requires much more data than the microprocessor where the data cache 80 is not large enough and the vector coprocessor 100 can pollute data cache 85. In one embodiment, the load and store data for the vector coprocessor 100 is from L2C 185. The vector coprocessor 100 can also access the LVM 285 or the external memory (not shown). Second, the microprocessor 10 and the vector coprocessor 100 should access different memory regions where the vector load and store instructions should not hit in data cache 85. In another embodiment, if the vector load and store instructions hit in the data cache 85, then the microprocessor 10 should resolve all memory data dependency before sending the vector load and store data to the vector coprocessor 100 in which case, the vector coprocessor 100 is strictly loading or storing data directly to the vector data memory. Third, the vector load and store instructions must be in the same translation look-aside buffer (TLB) page, the memory region of physical memory protection/attribute (PMP/PMA). The vector load and store instructions can be for several vector registers in which a large memory data is needed. In another embodiment, to simplify the implementation, the memory access for vector load and store instruction must be in the same TLB page or PMP/PMA. Fourth, the vector load and store data may require permutation of the memory data from or to vector registers in which complex operation is needed. Yet, in another embodiment, vector load and store instructions are restricted to only unit load/store type for data from external memory in which the latency can be hundreds of cycles and may arrive out-of-order due to hyperscalar routing of data through a large network of processing elements. Other types (i.e. stride or index) of vector load or store instruction can be used by prefetching of data into L2C 185 or LVM 285.

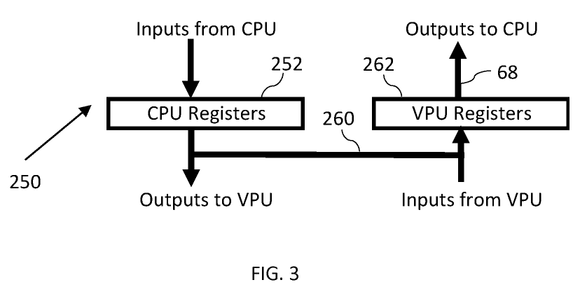

FIG. 3 illustrates a block diagram of a preferred embodiment of the interface module 250. The interface module 250 includes a set of CPU registers 252 for data from many different units of the microprocessor 10 to the VIQ 120 through bus 260, a set of VPU registers 262 from the VIQ 120 to implementation of the interface module 250. The CPU registers 252 includes data from the decode unit 30, the vector execution queue 70, and the ROB 45. The VPU registers 262 includes the data from the VIQ 120 the result data from the vector issue and execution unit 125 (FIG. 1) particularly from the vector functional unit 175 (FIG. 2). This interface module 250 does not include any vector load or store data from vector data memory which is part of the memory interface module 210. The assumption is that all interface data between the microprocessor 10 and the vector coprocessor 100 can be flopped and sent in a next cycle to avoid any timing path. The decode unit 30 sends the vector instructions to the VIQ 120 but the vector coprocessor does not issue the instructions to the vector issue and execution unit 125 until the instructions are committed by the ROB 45 at later time. Once the committed signals from ROB 45 are sent to the VIQ 120 the vector instructions can be executed at any time and can start in a later cycle. The vector execution queue 70 along with the register file 60 can send the vector information and data to the VIQ 120 but the vector instruction must still wait for the commit signals from the ROB 45 in which case writing the data into the register for a next cycle is acceptable. Once the vector instruction is committed, the vector instruction can be sent to vector decode unit 130 for decoding and execution of the vector instruction. Few vector instructions will write result data back to the register file 60 through the VPU registers 262. This results in an additional cycle to reset the register scoreboard 40 and the write to the register file 60 is performed in the next cycle. In FIG. 1, the register scoreboard 40 is used as the main mechanism for handling of data dependency and as such, the register scoreboard is also used to indicate a write to a register in the register file is pending until the vector instruction is executed. Upon instruction execution, the result data is sent to the VPU registers 262 to write to the register file 60. The corresponding scoreboard bit of the register scoreboard 40 is then cleared. In another embodiment, the register scoreboard 40 is used to keep track of only pending result data from execution of a vector instruction from the vector coprocessor 100. The processor 10 can implement a different mechanism to handle data dependency.

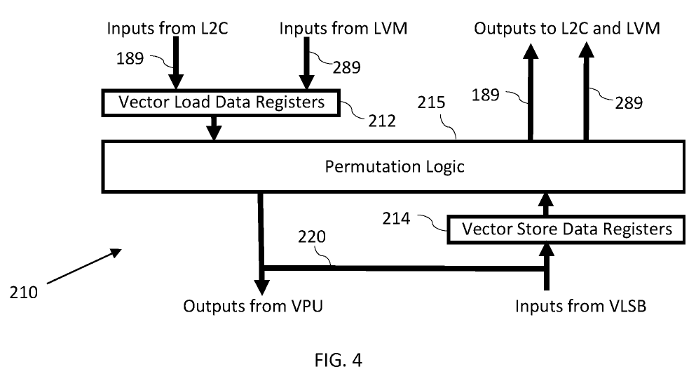

FIG. 4 illustrates a block diagram of a preferred embodiment of the memory interface module 210 which is coupled to the L2C 185, LVM 285, and the VLSB 195 to transfer data between these modules. The memory interface module 210 is replicated for the number of vector data ports from the L2C 185 and LVM 285 in accordance with the number of load-store ports of the load-store unit 80 of the microprocessor 10. In one embodiment, the load-store unit 80 has 2 load-store ports and 2 tag arrays in the data cache 85 in which case the L2C 185 and LVM 285 also have 2 independent access ports. The buses 189 and 289 represent 2 data ports coupled between the L2C 185 and LVM 285 to the vector load data registers 212 of the memory interface module 210, and the bus 220 represents 2 data ports coupled between the memory interface module 210 and the VLSB 195. The vector load data registers 212 can have multiple entries to receive data from either the L2C 185 through bus 189 or the LVM 285 through bus 289 wherein the data will be stalled in the L2C 185 or LVM 285 if the vector load data registers 212 is full. The vector gather load instruction remains in the L2C 185 or the LVM 285 until the vector index register is received by the memory interface module 210 at which time the cache lines will be read from L2C 185 or the LVM 285 and sent to the memory interface module 210 for the gather operation. The vector load data from the vector load data register 212 is coupled to the permutation logic 215 for the permutation function before sending on the bus 220 to the VLSB 195. The permutation logic 215 includes but is not limited to stride, scatter and gather operations. The permutation function could be a none or stride or gather operation depending on the vector load type. In another embodiment, the L2C 185 and LVM 285 are designed as private memories for the vector coprocessor 100 where the multiple vector registers can store data directly to these private memories. The memory interface module 210 can perform permutation for vector store data between the VLSB 195 to the private memories. The vector store data is written in case of the gather operation (vector index load instruction) or the vector scatter operation (vector index store instruction), the index for the gather or scatter operation is from a vector register of the vector register file 160 in the vector coprocessor 100. The vector store data from the VLSB 195 is written into the vector store data registers 214 before sending to the permutation logic 215. The permutation logic 215 sends the vector store data to L2C 185 through bus 189 or to LVM 285 through bus 289. The permutation function could be a none or stride or scatter operation depending on the vector store type. Yet in another embodiment, the memory interface module is responsible to align data before sending to the VLSB 195 wherein the unaligned access means that the cache line address bits are not 0 indicating that the first byte is not the least significant byte of the cache line.

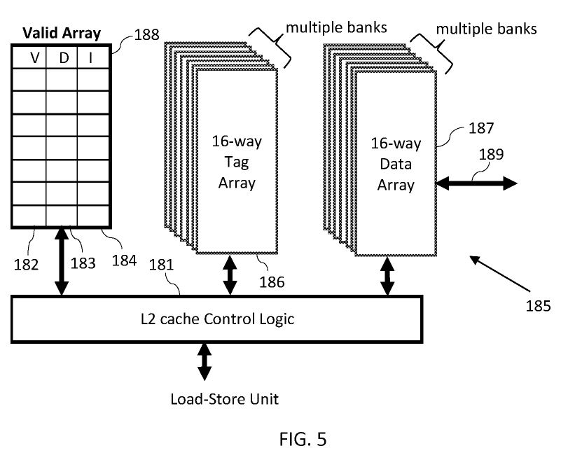

FIG. 5 illustrates a block diagram of a preferred embodiment of the valid, dirty, and inclusion array of the L2C 185; this array is referred to as L2 cache valid array. The L2C 185 includes tag arrays 186, data arrays 187, valid arrays 188, and L2 cache control logic 181. In one embodiment, the tag arrays 186 may comprise 2 sets of tag arrays to match with the number of load-store ports in the load-store unit 80. The vector load-store instruction may include multiple cache lines and the tag array 186 may include multiple bank arrays for parallel accesses in a single cycle. The banks may be accessed in parallel for multiple sequential cache lines by a corresponding coprocessor vector load or store instruction and multiple tag hit or miss indications in the tag array 186 can consequently be generated concurrently. In one example, the tag array 186 includes 8 tag-array banks wherein 8 consecutive cache lines for a vector load or store instruction can be accessed in a single clock cycle. In another embodiment, the data array 187 may include multiple sets of 8-bank arrays in which all 8 banks can be accessed in parallel for a vector load or store instruction. The data array 187 is coupled with the memory interface unit 210 through bus 189. The control logic 181 provides the control signals for reading/writing to all the arrays, determining L2 cache tag hit/miss, receiving, storing, and pipelining of requests from the microprocessor 10, requesting data from external memory when there is a cache miss, handling of coherency for the L1 data cache 85 and L2 data cache 185, returning cache line data to the microprocessor 10, and interfacing to the vector coprocessor 100. The above list of functions for the control logic 182 is a partial list. The valid array 188 includes a valid bit 182, a dirty bit 183, and an inclusion bit 184 for each cache line. The valid array 188 may include other bits for coherency. The valid array 188 is preferably implemented as register cells for fast and multiple accesses.

The inclusion bit 184 is set when the cache line from L2C 185 is sent to the load-store unit 80 or the instruction cache 24. The inclusion bit 184 is reset when the cache line is evicted from the data cache 85 to the L2C 185. In one embodiment, load-store unit 80 and the instruction cache 24 send signals to clear the inclusion bits when a cache line is invalidated from the data cache 85 and the instruction cache 24, respectively. The invalidation of a cache line includes replacement of an entry in the data cache 85, a cache maintenance operation to invalidate a cache line, and a branch misprediction to invalidate a recent fetch cache line from L2C 185. In another embodiment, the data cache 85 and the instruction cache 24 do not need to inform the L2C 185 on invalidation. When the L2C 185 needs to invalidate or evict a cache line and if the inclusion bit 184 of the cache line is set, then the L2C 185 sends signals to invalidate or flush a cache line in the data cache 85 or the instruction cache 24. In some cases, the cache line may not be in the data cache 85 or the instruction cache 24 because the fetched cache line was cancelled and not written into the data cache 85 or the instruction cache 24. In one embodiment, since the vector load and store can access multiple cache lines and could be in conflict with other load and store access in the microprocessor 10, only the first cache line access a load-store port of the load-store unit 80 to the data cache 85 and subsequent cache lines access the L2C 185. Properly written software should set up different memory region for the vector operations and not interfere with the scalar operations in the microprocessor 10. The multiple sequential cache lines can access the L2C 185 in a single clock cycle. The inclusion bits 184 are read to determine if the cache line is also in the data cache 85. If none of the inclusion bits is set, then the cache lines for the vector load or store instructions can be directly transferred between the L2C 185 and the VLSB 195 through the memory interface module 210, else the vector load or store instruction is cancelled and the cache lines with inclusion bits are returned to the miss request queue 82 to flush or invalidate the “inclusion” cache lines before sending the vector load or store instruction request back to the L2C 185.

In another embodiment, the LVM 285 can be accessed similar to the L2C 185 where a single cache line or multiple cache lines can be accessed for the memory interface module 210. The LVM 285 is configured to fetch single or multiple consecutive cache lines. The LVM 285 is further configured to hold on to the vector processor request until the index vector register is received from the vector coprocessor 100.

At design time at the RTL level, in some embodiments, the units related to the custom and extended instructions as shown in the block diagram of FIG. 2 can be specified using software scripts. For example, a hardware description language (such as Verilog) that describes the functions performed by the additions of the custom and/or extended instructions of FIG. 2 can be modified by software scripts. The vector execution queues 170 and the vector functional units 175 are designed to be configurable for any custom or extended instructions which can be added to the microprocessor 10 by a software script. In one embodiment, custom functional units can be added to a particular implementation of the microprocessor 10 by adding new instruction decode table and parameters. A software script instantiates the custom decode block, functional units, and execution queue to the design. In another embodiment that employs another simpler customization, the number of functional units (same type) 175 can be added or removed by setting parameters which can be used by a software script to modify the instantiation of the functional units. The vector execution queues 170 receive instructions from the issue unit and send to the functional units which are added and removed by the software script.

The software scripts are part of the software representations can be implemented employing computer-executable instructions, such as those included in program modules and/or code segments, being executed in a computing system on a target real or virtual processor. The functionality of the program modules and/or code segments may be combined or split between program modules/segments as desired in various embodiments. Computer-executable instructions for program modules and/or code segments may be executed within a local or distributed computing system. The computer-executable instructions, which may include data, instructions, and configuration parameters, may be provided via an article of manufacture including a non-transitory computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

The foregoing explanation described features of several embodiments so that those skilled in the art may better understand the scope of the invention. Those skilled in the art will appreciate that they may readily use the present disclosure as a basis for designing or modifying other processes and structures for carrying out the same purposes and/or achieving the same advantages of the embodiments herein. Such equivalent constructions do not depart from the spirit and scope of the present disclosure. Numerous changes, substitutions and alterations may be made without departing from the spirit and scope of the present invention.

Although illustrative embodiments of the invention have been described in detail with reference to the accompanying drawings, it is to be understood that the invention is not limited to those precise embodiments, and that various changes and modifications can be affected therein by one skilled in the art without departing from the scope of the invention as defined by the appended claims.

What is claimed is:

1. A processor-based data processing system that includes a coprocessor coupled to a processor, the data processing system comprising:
an interface module comprising a plurality of registers to receive coprocessor instructions from the processor and a plurality of registers to receive status information from the coprocessor wherein the status information from the coprocessor comprises a coprocessor queue entry number which is used to track a corresponding coprocessor instruction through pipelines of the processor and the coprocessor;
a level two cache for storage of data of the coprocessor wherein the data for the coprocessor is not from a data cache of the processor and wherein a coprocessor load and store instruction is tagged with a coprocessor queue entry number;
a memory interface module comprising
a plurality of first registers to receive coprocessor data from the level two cache to send to the coprocessor, and
a plurality of second registers to receive coprocessor data from the coprocessor to send to the level two cache; and
wherein the coprocessor data in the memory interface module is tagged with the coprocessor queue entry number.

2. The data processing system of claim 1, wherein the processor provides validation or cancellation regarding the corresponding coprocessor instruction sent to the coprocessor and wherein the validation is provided after a commit state in the processor.

3. The data processing system of claim 1, wherein the level two cache further comprises:
an inclusion bit for each cache line in the level two cache in a valid array to indicate the cache line is also present in the data cache in the processor and wherein the processor resets the inclusion bit when the corresponding cache line is no longer in the data cache; and
wherein the processor does not reset the inclusion bit when the cache line is invalidated in the data cache.

4. The data processing system of claim 1, wherein the level two cache further comprises:
a tag array comprising multiple banks wherein the banks are accessed in parallel for multiple sequential cache lines by a corresponding coprocessor vector load or store instruction and wherein multiple tag hit or miss are generated concurrently; and
a data array comprising multiple banks wherein the banks are accessed in parallel for multiple sequential cache lines wherein multiple cache lines are read concurrently from the data array.

5. The data processing system of claim 1, wherein the level two cache further comprises:
a plurality of tag arrays wherein each of the tag arrays corresponds to a load-store port of load-store units of the microprocessor.

6. The data processing system of claim 1, further comprising a local vector memory wherein the local vector memory comprises:
a plurality of memory blocks wherein each memory block comprises a start address and wherein size of the memory block is equivalent to a plurality of cache lines of the level two cache and wherein a single cache line or multiple cache lines can be concurrently accessed;
an access port corresponding to each load-store port of load-store units of the microprocessor;
storage for a coprocessor load instruction that accesses a memory block to read coprocessor load data when the coprocessor sends an index register to the memory interface module; and
storage for a coprocessor store instruction that accesses a write coprocessor store data from the memory interface module.

7. The data processing system of claim 1, wherein the memory interface module further comprises permutation logic that comprises:
circuitry that performs a stride operation; and
circuitry that performs a gather operation for a coprocessor load operation;
circuitry that performs a scatter operation for a coprocessor store operation; and
circuitry that performs alignment of coprocessor data.

8. The data processing system of claim 1, wherein the coprocessor further comprises:
a clock circuit;
a coprocessor time counter storing a coprocessor time count representing a current time of the coprocessor, wherein the coprocessor time count is incremented with each cycle of the clock circuit;
a coprocessor register file comprising a plurality of coprocessor registers;
a coprocessor instruction issue unit coupled to the coprocessor time counter for receiving a first coprocessor instruction, and issuing the first coprocessor instruction with a preset coprocessor execution time based on the coprocessor time count;
a coprocessor execution queue coupled to the coprocessor time counter and the coprocessor instruction issue unit to receive the first coprocessor instruction, and dispatch the first coprocessor instruction to a functional unit when the coprocessor time count matches the preset coprocessor execution time;
a coprocessor register scoreboard storing a write time of a coprocessor register in a coprocessor register file, wherein the write time is a future time specified by the coprocessor time count;
a coprocessor instruction decode unit coupled to the coprocessor register scoreboard in which the coprocessor instruction decode unit reads write times for source operands of the first coprocessor instruction from the coprocessor register scoreboard, and uses the write times to determine an execution time for the first coprocessor instruction;
a coprocessor time-resource matrix coupled to the coprocessor register scoreboard and the coprocessor time counter for storing information relating to available coprocessor resources for each coprocessor time count of the coprocessor time counter and
wherein the available coprocessor resources include at least one of: a plurality of coprocessor read buses, a plurality of coprocessor write buses, and a plurality of coprocessor functional units.

9. A data processing system that includes a coprocessor coupled to a processor, the data processing system comprising:
an interface module comprising a plurality of first interface registers to receive coprocessor instructions from the processor and a plurality of second interface registers to receive status information from the coprocessor wherein the status information from the coprocessor comprises a coprocessor queue entry number used to track the coprocessor instruction throughout the processor and the coprocessor pipelines;
a level two cache for storage of data of the coprocessor wherein the data for the coprocessor is not from the data cache in the processor wherein coprocessor load and store instructions are tagged by the coprocessor queue entry number;
a memory interface module comprising a plurality of first interface module registers that receive coprocessor data from the level two cache and provide the coprocessor data to the coprocessor and a plurality of second interface module registers that receive coprocessor data from the coprocessor and provide the coprocessor data to the level two cache, the memory interface module further comprising:
circuitry that performs a stride operation; and
circuitry that performs a gather operation for a coprocessor load operation;
circuitry that performs a scatter operation for a coprocessor store operation; and
circuitry that performs alignment of coprocessor data;
valid array that includes an inclusion bit for each cache line in the level two cache to indicate that a corresponding cache line is also present in a data cache in the processor and wherein the inclusion bit is reset by the processor when the corresponding cache line is no longer in the data cache; and the coprocessor data in the memory interface module are tagged with the coprocessor queue entry number.

10. A computer program product for issuing a coprocessor instruction to a processor, the computer program product stored on a non-transitory computer readable storage medium and including instructions for causing a computer system to execute a method that is executable by a data processing system, the method comprising:
assigning a coprocessor queue entry number through an interface module to the coprocessor instruction to track a coprocessor instruction progress through pipelines of the coprocessor and the processor;
committing or cancelling, by the processor via the interface module, the coprocessor instruction;
sending, via a memory interface module, coprocessor load data to the coprocessor from a level two cache; and
receiving and storing coprocessor store data to the level two cache through the memory interface module.

11. The computer program product of claim 10, wherein the method further comprises:
reading a single or a plurality of cache lines from the level two cache; and
sending the single or plurality of cache lines to the coprocessor through the memory interface module.

12. The computer program product of claim 10, wherein the method further comprises:
writing a single or a plurality of cache lines from the coprocessor to the level two cache through the memory interface module.

13. The computer program product of claim 10, wherein the method further comprises:
performing a stride operation on coprocessor load or store data in the memory interface module;
performing a gather operation on the coprocessor load data in the memory interface module; and
performing a scatter operation on the coprocessor store data in the memory interface module.

14. The computer program product of claim 10, wherein the method further comprises:
storing a coprocessor load instruction in the level two cache until coprocessor index data is available from the coprocessor through the memory interface module.

15. The computer program product of claim 10, wherein the method further comprises:
storing a coprocessor store instruction in the level two cache until the coprocessor store data is available for writing into the level two cache from the memory interface module.

16. The computer program product of claim 10, wherein the method further comprises:
resolving data dependency for the coprocessor load or store instruction in the processor before sending the coprocessor load or store instruction to the level two cache.

17. The computer program product of claim 10, wherein the method further comprises:
storing an inclusion bit for each cache line in the level two cache and replaying the coprocessor load or store instruction if the inclusion bit is set for a corresponding coprocessor load or store cache line.

18. The computer program product of claim 10, wherein the method further comprises:
storing a plurality of memory blocks in a local vector memory wherein the memory block comprises a start address and the size of the memory block is equivalent to plurality of cache lines of the level two cache and wherein a single cache line or multiple cache lines can be concurrently accessed;
accessing the local vector memory for a number of coprocessor load and store requests which is the same as the number of load-store ports of the load-store units of the microprocessor;
storing a coprocessor load instruction and accessing a memory block to read coprocessor load data when the coprocessor sends an index register to the memory interface module; and
receiving a coprocessor store data from the memory interface module wherein the coprocessor store data is from the coprocessor in accordance with the coprocessor store instruction.

19. The computer program product of claim 10, wherein the method further comprises:
periodically incrementing a coprocessor time counter to provide a maximum time count corresponding to a latest future time to issue latest instruction;
receiving a first coprocessor instruction, and issuing the first coprocessor instruction with a preset coprocessor execution time based on the coprocessor time count;
receiving the first coprocessor instruction and storing the first coprocessor instruction with an execution time in a coprocessor execution queue and dispatching the first coprocessor instruction to a functional unit when the coprocessor time count matches the preset coprocessor execution time;
storing a write time in a coprocessor register scoreboard of a coprocessor register in a coprocessor register file, wherein the write time is a future time specified by the coprocessor time count;
reading write times from a register in the coprocessor register scoreboard for source operands of the coprocessor, and using the write times to determine an execution time for the first coprocessor instruction;
storing information relating to available coprocessor resources for each coprocessor time count of the coprocessor time counter into a coprocessor time-resource matrix coupled to the coprocessor register scoreboard, and wherein the available coprocessor resources include at least one of: a plurality of coprocessor read buses, a plurality of coprocessor write buses, and a plurality of coprocessor functional units.
